(19) United States
(12) Patent Application Publication
(10) Pub. No.: US 2019/0282974 A1
(43) Pub. Date: Sep. 19, 2019

(54) APPARATUS AND METHOD FOR FORMING A GAS-LIQUID MIXTURE HAVING A STABLE VAPOR CONCENTRATION

(71) Applicant: JIANGSU LEUVEN INSTRUMMENTS CO. LTD, Jiangsu (CN)

(72) Inventors: Konstantin P MOGILNIKOV, Jiangsu (CN); Kaidong XU, Jiangsu (CN)

(21) Appl. No.: 16/427,422

(22) Filed: May 31, 2019

Related U.S. Application Data
(63) Continuation of application No. PCT/CN2017/099607, filed on Aug. 30, 2017.

(30) Foreign Application Priority Data
Dec. 7, 2016 (CN) 201611114997.9

(51) Int. Cl. B01F 5/00; B01F 3/04; B01F 5/04

(52) U.S. Cl. CPC B01F 5/00; B01F 2005/0097; B01F 5/04; B01F 3/04021

(57) ABSTRACT

Disclosed are an apparatus and a method for forming a gas-liquid mixture having a stable vapor concentration. The apparatus comprises a mixing unit (1), a guide unit (2) and an evaporation chamber (3). In the mixing unit (1), a liquid stream is directly injected into a gas stream to form a mixture. The mixture is guided into the evaporation chamber (3) through the guide unit (2). The liquid is able to be spread over the rough inner surface of the evaporation chamber (3) so as to form a gas-liquid mixture having a stable vapor concentration. The technique can be applied to adsorption measurements using ellipsometry, as well as other research and products requiring use of stable and very-low-speed fluids.

### CROSS REFERENCE TO RELATED APPLICATIONS

This is a Continuation application of International Application Serial No. PCT/CN2017/099607, filed on Aug. 30, 2017, which claims the benefit of Chinese Application No. 201611114997.9, filed on Dec. 7, 2016, the disclosures of which are hereby incorporated by reference.

### BACKGROUND

The present disclosure relates to an apparatus and a method for forming a gas-liquid mixture, and more particularly to an apparatus and a method for forming a gas-liquid mixture having a stable vapor concentration.

It is extremely important to form a vapor stream of various organic liquids that are managed and controlled for the study of adsorption process of chemical products as well as porous materials. Very small vapor streams (mass flow less than 1 g/h) are used for adsorption studies. Apparatuses and methods for forming a vapor stream are described in the following patent documents 1 to 3.

Patent Document 1 U.S. Pat. No. 6,161,398 A

Patent Document 2 U.S. Pat. No. 6,311,959 B1

Patent Document 3 U.S. Pat. No. 5,431,736 A

The apparatuses in Patent Document 1 and Patent Document 2 use a bubbler. In the method, a carrier gas is introduced into a liquid that needs to be evaporated. The carrier gas causes bubbles in the liquid to form a mixture of gas and vapor in an enclosed space above the surface of the liquid. The mixture is then output and can be used in a chemical deposition or adsorption process. However, this method has the disadvantage that the gas-liquid mixture is poor in continuity and stability, and the gas flow is often intermittent or interrupted from time to time. This disadvantage is particularly pronounced in the case of operation with a small gas stream (for example a mass flow range of 10 to 500 g/h).

In the apparatus described in Patent Document 3, a liquid stream is directly injected into a gas stream, and a mixture thereof is guided into a specific vapor chamber. In this method, the instability of the effluent gas stream and liquid stream is much less than the instability of the gas stream flowing out in a bubbler process. However, this method has the disadvantage that the instability of the vapor concentration in the effluent mixture, in particular in very small streams, for example less than 1 g/h, the vapor concentration is particularly unstable. This instability leads to the impossibility to use this apparatus to determine an adsorption process in modern ellipsometer systems.

### BRIEF SUMMARY

In order to solve the above problems, the present disclosure provides an apparatus for forming a gas-liquid mixture having a stable vapor concentration, comprising: a mixing unit that directly injects a liquid stream into a gas stream to form a mixture, a guide unit that guides the mixture into an evaporation chamber, and an evaporation chamber having a rough inner surface on which the liquid is able to be spread, forming a gas-liquid mixture having a stable vapor concentration.

In the apparatus for forming a gas-liquid mixture having a stable vapor concentration of the present disclosure, preferably, the rough inner surface is a stainless steel surface subjected to a mechanical treatment, a metal or non-metal surface formed by wet etching, or a metal or non-metallic surface formed by plasma etching.

In the apparatus for forming a gas-liquid mixture having a stable vapor concentration of the present disclosure, it is preferable that the rough inner surface is an electrochemically-treated titanium surface.

In the apparatus for forming a gas-liquid mixture having a stable vapor concentration of the present disclosure, it is preferable that the electrochemically-treated titanium surface is a porous titanium dioxide layer.

In the apparatus for forming a gas-liquid mixture having a stable vapor concentration of the present disclosure, it is preferred that the titanium dioxide layer has a thickness of 1 to 5 μm.

In the apparatus for forming a gas-liquid mixture having a stable vapor concentration of the present disclosure, preferably, the mechanical treatment is sand-papering.

In the apparatus for forming a gas-liquid mixture having a stable vapor concentration of the present disclosure, preferably, the electrochemical treatment uses a bipolar battery having a voltage range of 10 to 15 V, and uses an electrolyte solution with 0.25% ammonium fluoride dissolved in an ethylene glycol solution, and a treatment time is 1 to 10 minutes.

In the apparatus for forming a gas-liquid mixture having a stable vapor concentration of the present disclosure, preferably, the liquid is one of heptane, isopropanol, toluene, acetone, carbon tetrachloride, cyanide or any combination thereof.

The present disclosure also provides a method of forming a gas-liquid mixture having a stable vapor concentration, comprising: a mixing step of directly injecting a liquid stream into a gas stream to form a mixture; an guiding step of guiding the mixture into an evaporation chamber; and an evaporation step of spreading the liquid over a rough inner surface of the evaporation chamber to form a gas-liquid mixture having a stable vapor concentration.

In the method of forming a gas-liquid mixture having a stable vapor concentration of the present disclosure, preferably, the liquid is one of heptane, isopropanol, toluene, acetone, carbon tetrachloride, cyanide or any combination thereof.

The apparatus and method for forming a gas-liquid mixture having a stable vapor concentration of the present disclosure can be applied to adsorption measurements using ellipsometry, as well as other research and products requiring use of stable fluids of very low velocity.

### BRIEF DESCRIPTION OF THE SEVERAL VIEWS OF THE DRAWINGS

FIG. 1 is a functional block diagram of an apparatus for forming a gas-liquid mixture having a stable vapor concentration.

FIG. 2 is a functional block diagram of a mixing unit.

FIG. 3 is a schematic diagram showing different structures formed by droplets on surfaces of different wettability.

FIG. 4 are graphs of a contact angle on surfaces of different roughness versus a contact angle on a smooth surface.

FIG. 5 is a flow chart of a method of forming a gas-liquid mixture having a stable vapor concentration.

### DETAILED DESCRIPTION

To make the objects, solutions and advantages of the present invention much clearer, exemplary embodiments of the present disclosure will be described hereinafter clearly and completely with reference to the attached drawings. It should be appreciated that the specific embodiments described herein are only used to explain the invention rather than limiting the invention. The embodiments described are only portions of embodiments of the invention, rather than all embodiments of the invention. It is intended that all other embodiments obtained by those skilled in the art according to the disclosed embodiments without inventive labor are all within the scope of the present invention.

In the description of the present invention, it is to be noted that, unless otherwise specified or defined clearly, the terms of “connect”, “couple” and the like should be interpreted broadly. For example, they may refer to fixed connection, or detachable connection, or integral connection; they may refer to mechanical connection, or electrical connection; they may refer to direct connection, or indirect connection through an intermediate agent, or internal communication between two components. For those skilled in the art, the specific meaning of these terms in the present disclosure may be understood in combination with specific situations or contexts.

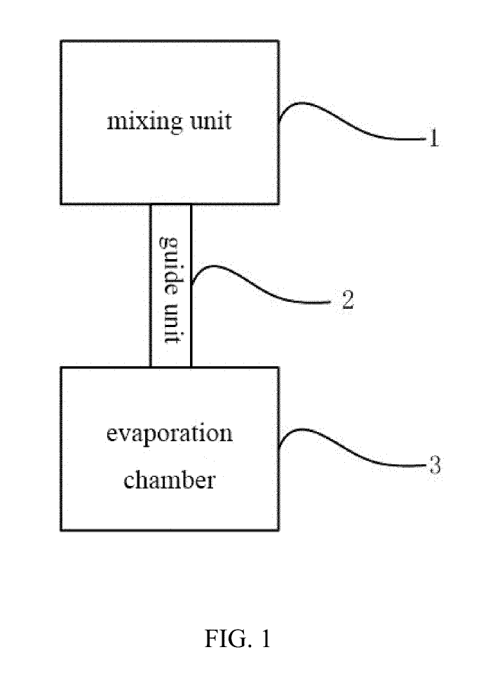

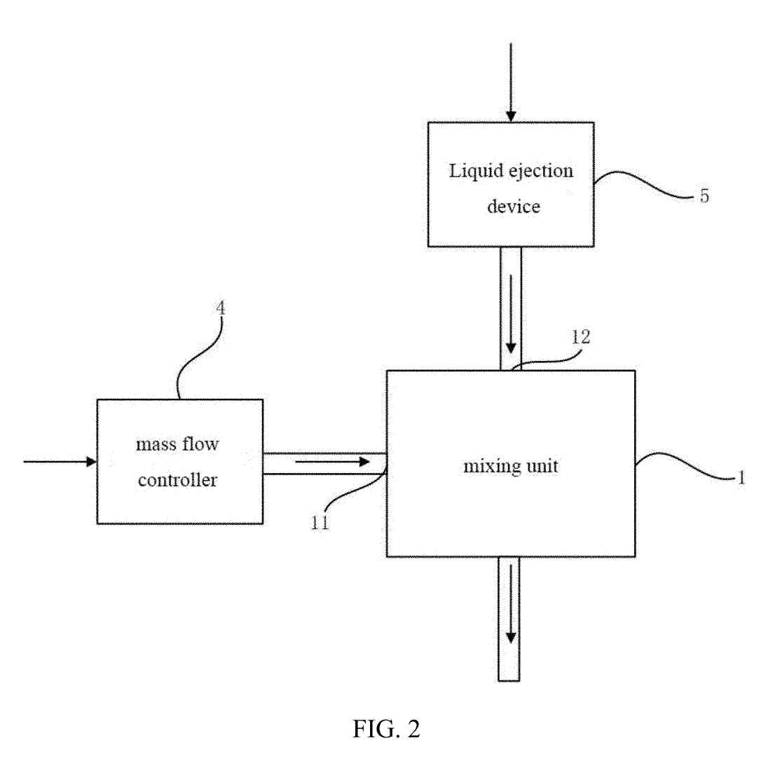

As shown in FIG. 1, an apparatus for forming a gas-liquid mixture having a stable vapor concentration includes a mixing unit 1, a guide unit 2 and an evaporation chamber 3. The mixing unit 1 injects a liquid stream directly into a gas stream to form a mixture. The guide unit 2 guides the mixture into the evaporation chamber 3. The liquid is an organic solution, such as heptane, isopropanol, toluene, acetone, carbon tetrachloride, cyanomethane or the like. The gas is a carrier gas, for example, an inert gas, such as nitrogen, argon or helium. In a specific example, as shown in FIG. 2, the mixing unit 1 has a gas intake port 11 and a liquid injection port 12. The gas intake port 11 is connected to a mass flow controller 4, and the liquid injection port 12 is connected to a liquid ejecting device 5. The gas stream enters the mixing unit 1 from the gas intake port 11 via the mass flow controller 4, and the liquid ejecting device 5 ejects the liquid through the liquid ejecting port 12 into the gas stream to form a mixture. Arrows in this figure show flowing directions of liquids, gases and mixtures. However, the present invention is not limited thereto, and the guide unit may have a plurality of gas intake ports and a plurality of liquid injection ports.

The evaporation chamber 3 is connected to the guide unit 2, in which a gas-liquid mixture is formed. In order to avoid unstable vapor concentration in the effluent mixture, in some embodiments of the present invention, an inner surface of the evaporation chamber is treated to enhance the wettability of certain adsorbates with respect to the surface.

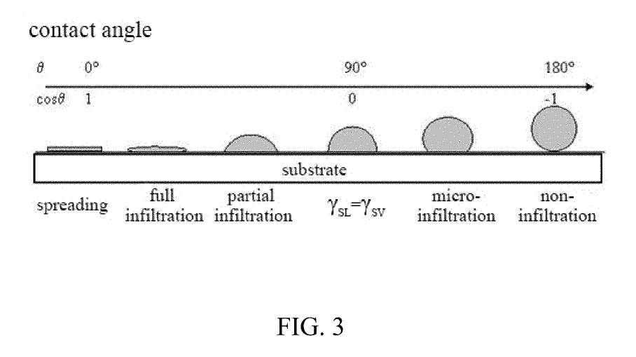

The inventors analyzed instability of vapor concentration in an effluent mixture. By measuring the adsorbate that is completely infiltrated on the surface of the evaporator and spread on the surface, it is found that the complex evaporation process in the evaporation chamber determines the concentration of vapor in the effluent mixture. In this apparatus, the liquid is injected into the gas stream to form droplets of different shapes. These droplets fall on the evaporation surface of the evaporation chamber, forming a variety of different shapes of construction, as shown in FIG. 3. In the case where the droplet is less wettable with respect to the surface of the evaporation chamber, for example, when the contact angle is 180 degrees, the droplet is almost standing on the surface of the evaporation chamber.

The relationship between an evaporation time and a size of free droplets is as follows:

t=Kr²,

where t is time, K is a coefficient which depends on liquid properties, atmospheric pressure, temperature, and other parameters, and r is a radius of the droplet.

For sessile droplets, the relationship will change and there will be no analytical solution, but the characteristic time of evaporation will remain the same. Usually, this time is about tens of seconds. For example, the evaporation time of droplets having a size of 100 to 300 microns can vary from 10 seconds to 100 seconds. During this time, if more droplets fall into the evaporation chamber, they will evaporate quickly, or can fuse with the sessile droplets and thus their evaporation will be further delayed. This complex process results in an unstable vapor concentration of the adsorbate in the effluent mixture when there are stable inflow gas streams and inflow liquid streams.

However, when the droplet spreads on the surface of the evaporation chamber, that is, when the contact angle is 0 degree, the situation changes radically in that the falling droplet leaves a thin layer of liquid on the surface of the evaporation chamber, and the evaporation rate of the liquid thin layer is nearly a hundred times the evaporation rate of a droplet with the same volume and a contact angle of 90 degrees. An immediate falling of a following droplet causes an increase in the area of the infiltration rather than local drying, so that the evaporation rate and the evaporation concentration are kept constant.

Next, the wettability of the surface of the evaporation chamber is changed by special treatment so that the droplets are all formed on the surface of the evaporation chamber in a spread configuration.

It is well known that the wettability of a rough surface changes with respect to the wettability of a smooth surface of the same material. A contact angle on a rough surface can be obtained by the Wenzel equation:

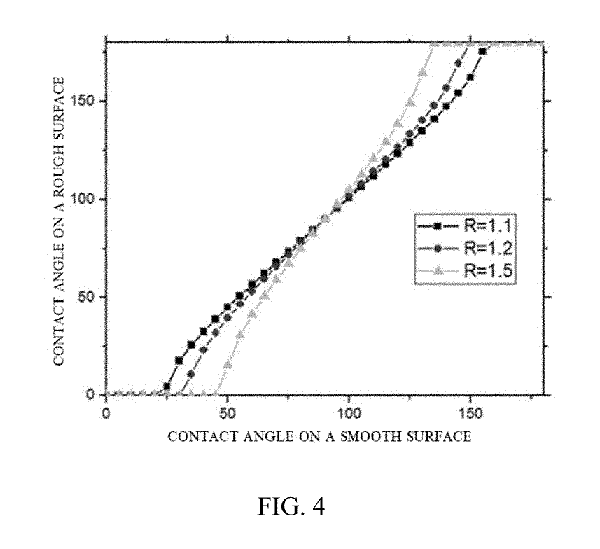

cos(θᵣ)=R cos(θₛ),

where θᵣ is a contact angle of a rough surface, θₛ is a contact angle of a smooth surface, and R is a ratio of an actual rough surface to an ideal flat surface under a droplet. FIG. 4 shows graphs of a contact angle on rough surfaces with different initial contact angles versus a contact angle on a smooth surface calculated according to the Wenzel equation. The graphs show contact angles on the surfaces with different roughness. A contact angle of an infiltrating liquid is saturated at 0 degree, which means that the liquid spreads over a surface having the roughness R. Thus, we can obtain the roughness of the surface.

Thereby, the surface of the evaporation chamber is treated by a mechanical process, an electrochemical process, a wet etching, a plasma etching or the like to obtain the predetermined roughness mentioned above, so that the liquid can be completely spread on the surface of the evaporation chamber to form a gas-liquid mixture having a stable vapor concentration, which will be explained by the following two examples.

As to a method to create a surface of a certain roughness by a mechanical process, specifically, for example, for a stainless steel surface, mechanically grinding the stainless steel with a medium-sized sandpaper to form a surface of a predetermined roughness. Thereafter, the wettability of different adsorbates with respect to the substrate is examined. As a result, it is found that all adsorbates are spread on the treated surface of the treated stainless steel which means that the mechanically treated stainless steel surface can be used as an inner surface of the vaporization chamber to produce a gas-liquid mixture with a stable vapor concentration of adsorbate. The adsorbate is, for example, heptane, isopropanol, toluene, acetone, carbon tetrachloride, or cyanomethane.

As to a method to create a surface of a certain roughness by a chemical process, specifically, taking a titanium surface as an example, by examining the wettability of different adsorbents with respect to the titanium surface, it is found that a contact angle on a smooth titanium surface is 10 to 40 degrees. The surface is electrochemically-treated using a bipolar battery having a voltage range of 10 to 15 V, and the electrolyte used is a solution of 0.25% ammonium fluoride dissolved in an ethylene glycol solution. The time for treating is 1 to 10 minutes. This treatment results in a porous titanium dioxide layer having a thickness of 1 to 5 μm on the surface of the titanium. As a result, all adsorbates are spread on the electrochemically-treated titanium surface. This means that the surface can be used as an inner surface of the evaporation chamber, producing a gas-liquid mixture with a stable vapor concentration of adsorbate. The adsorbate is, for example, heptane, isopropanol, toluene, acetone, carbon tetrachloride, or cyanomethane.

However, the present invention is not limited thereto, and the material of the evaporation chamber may be various materials, and the surface treatment method may be various methods. For example, the surface may be a metal or non-metal surface formed by wet etching, or a metal or non-metal surface formed by plasma etching. Among them, the wet etching can utilize any acid or alkali, for example, a single acid, alkali or a mixing solution with a pH between 3 and 11, or a solution directly reacting with a metal or a non-metal material, such as hydrogen peroxide, or an organic solvent or the like. The plasma etching may use a plasma formed by a fluorine-based gas, a chlorine-based gas, a bromine-based gas, an inert gas, oxygen gas, nitrogen gas, or a mixed gas thereof. The plasma etching can be performed on a reactive ion etching machine or an ion beam etching machine.

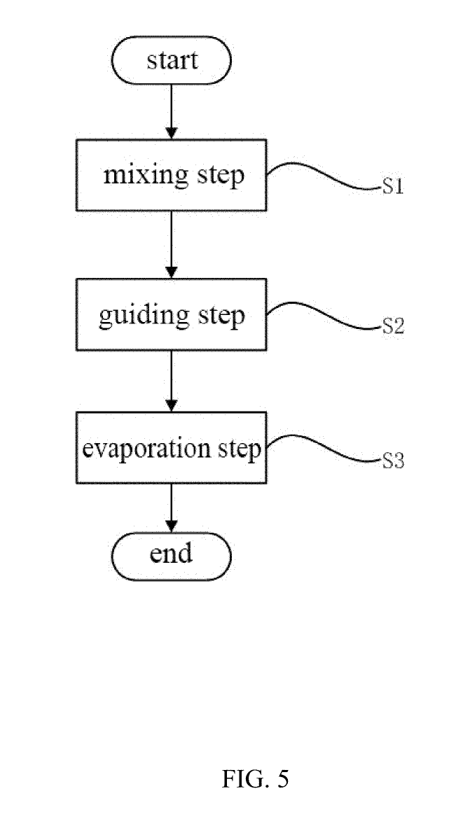

Hereinafter, a method of forming a gas-liquid mixture having a stable vapor concentration will be described with reference to FIG. 5.

First, in a mixing step S1, a liquid stream is directly injected into a gas stream to form a mixture in the mixing unit 1. Next, in a guide step S2, the mixture is guided into the evaporation chamber 3 by the guide unit 2. Finally, an evaporation step S3 is carried out to spread the liquid on the rough inner surface of the evaporation chamber 3 so as to form a gas-liquid mixture having a stable vapor concentration. The liquid may be an organic solution, such as heptane, isopropanol, toluene, acetone, carbon tetrachloride, cyanomethane or the like. The gas is a carrier gas, for example, nitrogen gas or an inert gas such as argon or helium.

The evaporation chamber may be made of a material such as stainless steel or titanium, and the inner surface thereof may be subjected to mechanical, chemical, or other treatment to form a predetermined roughness. For example, for a stainless steel surface, stainless steel is mechanically sanded using medium sandpaper so as to form a surface of predetermined roughness. For a titanium surface, the surface can be electrochemically-treated with a bipolar battery having a voltage range of 10 to 15 V. The electrolyte used may be 0.25% ammonia fluoride dissolved in an ethylene glycol solution, and the treatment time may be 1 to 10 minutes. This treatment results in a porous titanium dioxide layer with a thickness of 1 to 5 microns on the titanium surface. However, the present invention is not limited thereto. The material of the evaporation chamber may be various materials, and the surface treatment method may be various methods. For example, the surface may be a metal or non-metal surface formed by wet etching, or a metal or non-metal surface formed by plasma etching.

Regarding the setting of the roughness, it can be obtained by the Winzer equation with a standard that the liquid can be formed on the surface of the evaporation chamber in a spread configuration. The liquid, i.e., the adsorbate, selected for the surfaces made of different materials, may be different.

The apparatus and method for forming a gas-liquid mixture having a stable vapor concentration according to the present disclosure can be applied to adsorption measurements using ellipsometry, as well as other research and products requiring use of stable and very-low-speed fluids.

The above is only specific embodiments of the present invention, but the scope of the present invention is not limited thereto. Any changes or substitutions that can be easily considered by those skilled in the art within the technical scope of the present invention should be considered as falling in the scope of the present invention.

What is claimed is:

1. An apparatus for forming a gas-liquid mixture having a stable vapor concentration, comprising:
a mixing unit configured for directly injecting a liquid stream into a gas stream to form a mixture,
a guide unit configured for guiding the mixture into an evaporation chamber, and
the evaporation chamber having a rough inner surface on which the liquid is able to be spread so as to form a gas-liquid mixture having a stable vapor concentration.

2. The apparatus of claim 1, wherein the rough inner surface is a stainless steel surface subjected to a mechanical treatment, a metal or non-metal surface formed by wet etching, or a metal or non-metallic surface formed by plasma etching.

3. The apparatus of claim 1, wherein the rough inner surface is an electrochemically-treated titanium surface.

4. The apparatus of claim 3, wherein the electrochemically-treated titanium surface is a porous titanium dioxide layer.

5. The apparatus of claim 4, wherein the titanium dioxide layer has a thickness of 1 to 5 μm.

6. The apparatus of claim 2, wherein the mechanical treatment is sand-papering.

7. The apparatus of claim 3, wherein the electrochemical treatment uses a bipolar battery having a voltage range of 10 to 15 V, and uses an electrolyte solution with 0.25% ammonium fluoride dissolved in an ethylene glycol solution, and a treatment time is 1 to 10 minutes.

8. The apparatus of claim 1, wherein the liquid is one of heptane, isopropanol, toluene, acetone, carbon tetrachloride, cyanide or any combination thereof.

9. A method of forming a gas-liquid mixture having a stable vapor concentration, comprising:
a mixing step of directly injecting a liquid stream into a gas stream to form a mixture;
a guiding step of guiding the mixture into an evaporation chamber; and
an evaporation step of spreading the liquid over a rough inner surface of the evaporation chamber so as to form a gas-liquid mixture having a stable vapor concentration.

10. The method of claim 9, wherein the liquid is one of heptane, isopropanol, toluene, acetone, carbon tetrachloride, cyanide or any combination thereof.
